(19) United States
(12) Patent Application Publication
(10) Pub. No.: US 2024/0246876 A1
(43) Pub. Date: Jul. 25, 2024

(54) STABILIZED MICROBIAL CONSORTIUM IN STARTER FERTILIZER

(71) Applicant: DPH BIOLOGICALS, LLC, Princeton, IL (US)

(72) Inventors: Alex Jon Cochran, Princeton, IL (US); Clifford Watrin, Princeton, IL (US); Alexandria VanAusdall, Princeton, IL (US)

(21) Appl. No.: 18/417,691

(22) Filed: Jan. 19, 2024

Related U.S. Application Data
(60) Provisional application No. 63/480,853, filed on Jan. 20, 2023.

(51) Int. Cl. C05F 11/08; C05F 17/20

(52) U.S. Cl. CPC C05F 11/08; C05F 17/20

(57) ABSTRACT

A fertilizer composition comprising a stabilized microbial consortium comprising a plant-based humus extract; and a starter fertilizer, wherein the stabilized microbial consortium and the starter fertilizer are in a weight ratio of from about 1:4 to about 4:1 is disclosed, along with methods of using said composition.

### CROSS-REFERENCE TO RELATED APPLICATIONS

This application claims priority under 35 U.S.C. § 119 to provisional patent application U.S. Ser. No. 63/480,853, filed Jan. 20, 2023. The provisional patent application is herein incorporated by reference in their entirety, including without limitation, the specification, claims, and abstract, as well as any figures, tables, appendices, or drawings thereof.

### FIELD OF THE INVENTION

The present disclosure relates generally to a composition and method of fertilization for agricultural and horticultural crops.

### BACKGROUND OF THE INVENTION

The background description provided herein gives context for the present disclosure. Work of the presently named inventors, as well as aspects of the description that may not otherwise qualify as prior art at the time of filing, are neither expressly nor impliedly admitted as prior art.

Thus, there exists a need in the art a novel system for application of starter fertilizer in a more efficient manner.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows Corn Yield from South Dakota demonstrating increased yield from SP-1 in combination with starter fertilizer.

FIG. 2 shows Corn Yield from South Dakota demonstrating increased yield from SP-1 in combination with starter fertilizer.

FIG. 3 shows Corn Yield from Nebraska demonstrating increased yield from SP-1 in combination with starter fertilizer.

FIG. 4 shows Corn Yield from Iowa demonstrating differences in yield from SP-1 in combination with 6-24-6 starter fertilizer.

FIG. 5 shows Corn Yield from Minnesota (four locations) demonstrating difference in yield from SP-1 in combination with starter fertilizer.

FIG. 6 shows Corn Yield from Illinois demonstrating increased yield from SP-1 and starter fertilizer.

FIG. 7 shows SP-1 microbe consortia levels when tank mixed in UAN32 and stored for several months under ambient conditions.

FIG. 8 shows SP-1 microbe consortia levels when tank mixed in 10-34-0 and stored for several months under ambient conditions.

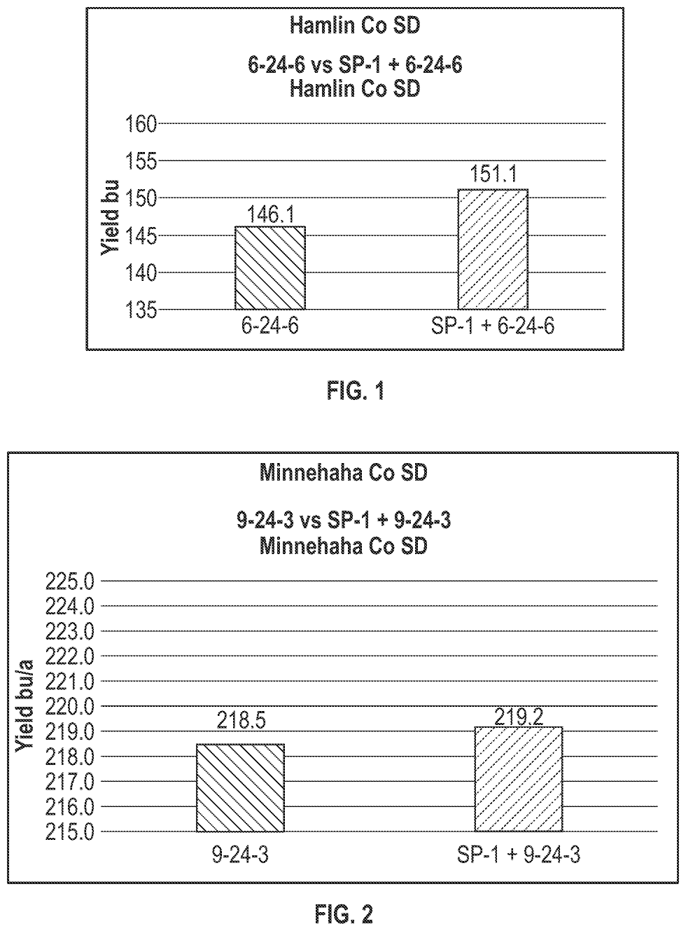

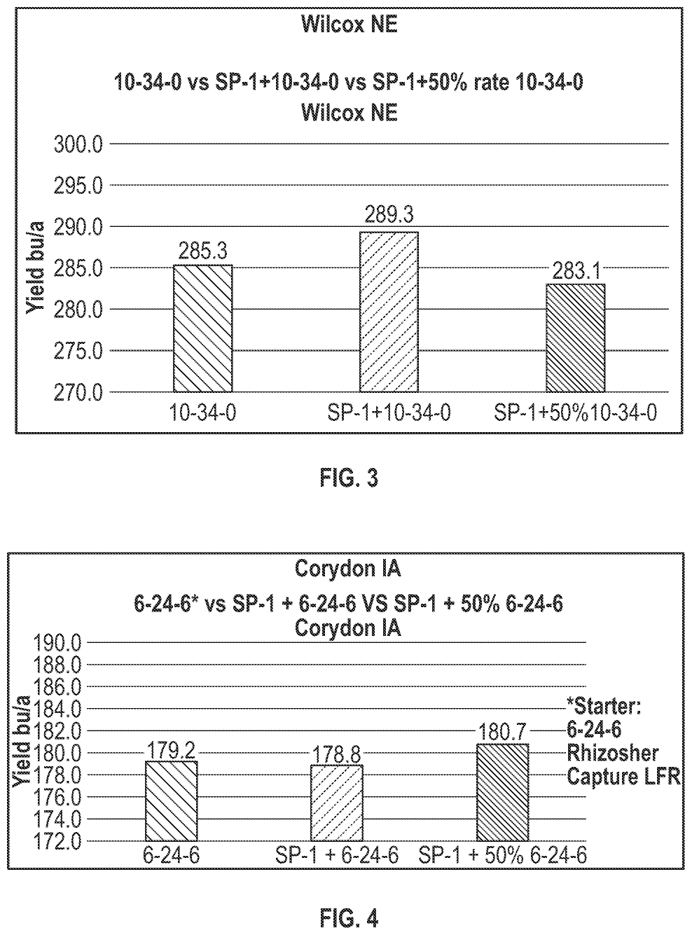

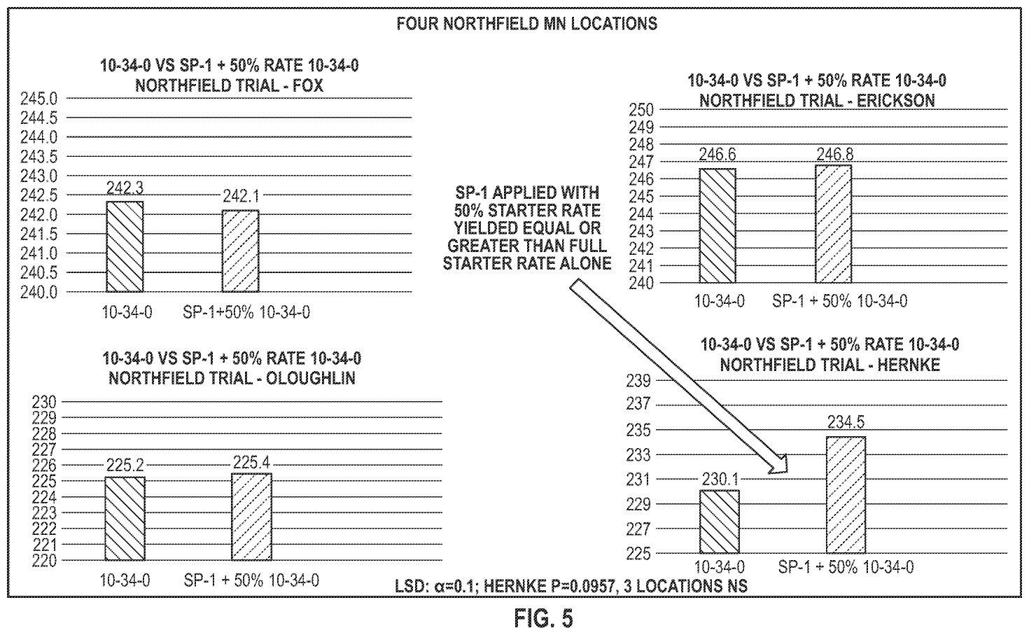

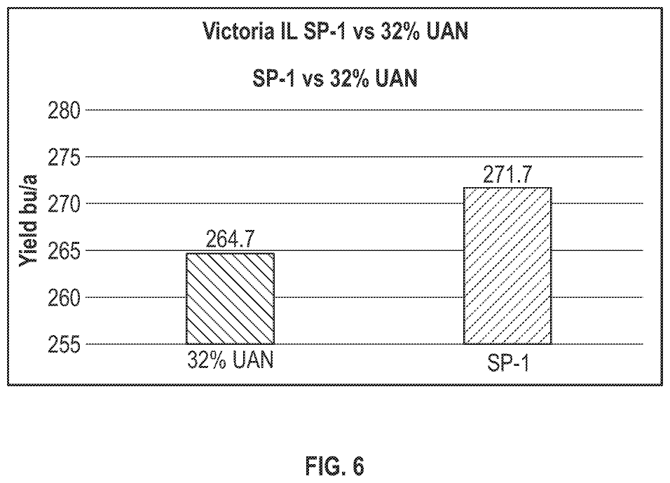

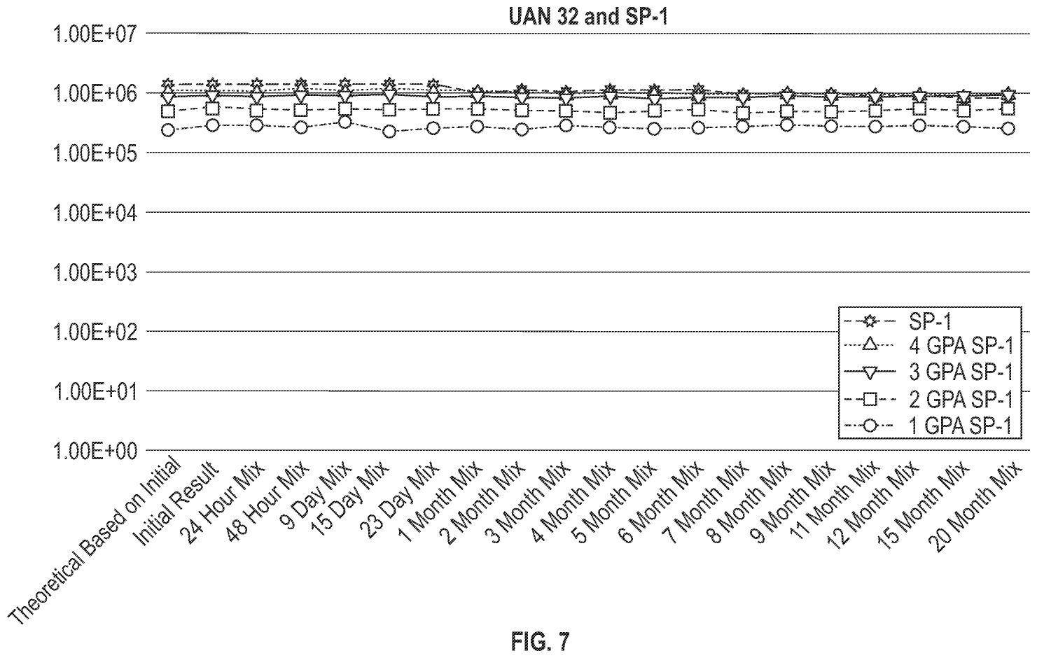

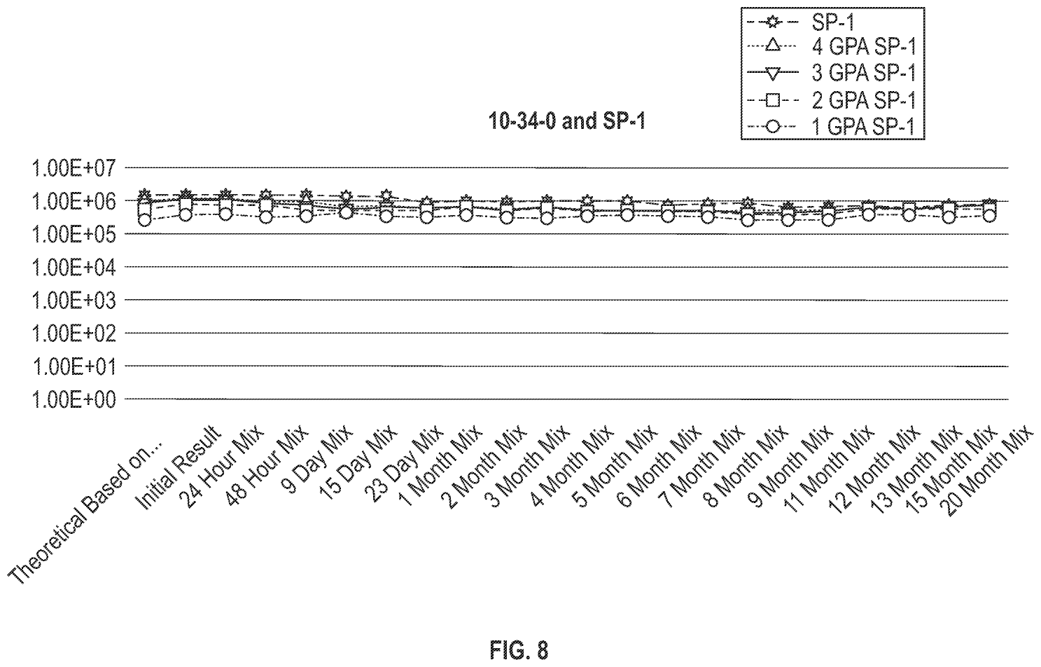

An artisan of ordinary skill need not view, within isolated figure(s), the near infinite number of distinct permutations of features described in the following detailed description to facilitate an understanding of the present disclosure.

### DETAILED DESCRIPTION OF THE INVENTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

In nature, the balance of microbial species in the soil is influenced by soil type, soil fertility, moisture, competing microbes, and plants (Lakshmanan et al., Plant Physiol. 166:689-700 2014). The interplay between microbial species and plants is further affected by agricultural practices, which can improve or degrade the soil microbiome (Adair et al., Environ. Microbiol. Rep. 5:404-413 2013; Carbonetto et al., PLOS One 9:e99949 2014; Ikeda et al., Microbes Environ. 29:50-59 2014). Fertile or highly productive soils contain a different composition of native microbes than soil that is depleted of nutrients and linked to low crop productivity. Different microbial species are associated closely with plants, on the above ground plant surfaces, at the root surface in the soil rhizosphere, or intimately as endophytes. Studies have determined complex microbiomes can be correlated to plant productivity, crop yield, stress tolerance, secondary metabolite accumulation, and disease tolerance (Bhardwaj et al., Microbial Cell Factories 13:66-75, 2014; Vacheron et al., Frontiers Plant Science 4:1-19 2014). Furthermore, plants can specifically select the microbial mixtures from the local environment and potentially fine-tune the microbiome at the level of crop variety (Hartmann et al., Plant Soil 321:235-257 2009; Doornbos et al., Agron. Sustain. Dev. 32:227-243 2012; Marasco et al., PLOS One 7:048479 2012; Peiffer et al. Proc. Natl. Acad. Sci. USA 110:6548-6553; Bulgarelli et al, Ann. Rev. Plant Biol. 64:807-838 2014).

Root-associated microbes can promote plant and root growth by promoting nutrient cycling and acquisition, by direct phytostimulation, by mediating biofertilization, or by offering growth advantage through biocontrol of pathogens. Agriculturally useful populations include plant growth promoting rhizobacteria (PGPR), pathogen-suppressive bacteria, mycorrhizac, nitrogen-fixing cyanobacteria, stress tolerance endophytes, plus microbes with a range of biodegradative capabilities. Microbes involved in nitrogen cycling include the nitrogen-fixing Azotobacter and Bradyrhizobium genera, nitrogen-fixing cyanobacteria, ammonia-oxidizing bacteria (e.g, the genera Nitrosomonas and Nitrospira), nitrite-oxidizing genera such as Nitrospira and Nitrobacter, and heterotrophic-denitrifying bacteria (e.g. Pseudomonas and Azospirillum genera; Isobe and Ohte, Microbes Environ. 29:4-16 2014). Bacteria reported to be active in solubilization and increasing plant access to phosphorus include the Pseudomonas, Bacillus, Micrococcus, and Flavobacterium, plus a number of fungal genera (Pindi et al, J. Biofertil. Biopest. 3:4 2012), while Bacillus and Clostridium species help solubilize and mobilize potassium (Mohammadi et at, J. Agric. Biol. Sci. 7:307-316 2012). Phytostimulation of plant growth and relief of biotic and abiotic stresses is delivered by numerous bacterial and fungal associations, directly through the production of stimulatory secondary metabolites or indirectly by triggering low-level plant defense responses (Gaiero et al, Amer. J. Bot. 100:1738-1750 2013; Bhardwaj et al. Microbial Cell Factories 13:66-76 2014).

As described herein, consortia of microbes derived from fertile soil and marine sources have been successfully co-fermented and stabilized, offering direct growth and yield benefits to crops. In some embodiments, direct delivery of microbial consortia and/or compositions can allow early root colonization and promote rhizosphere or endophytic associations. In some embodiments, benefits of delivery of microbial consortia to plants include one or more of increased root growth, increase root hair production, increased root surface area, stronger plants able to withstand transplantation shock, faster stand establishment, resistance to abiotic stress, and higher plant productivity and yield. Complex microbial mixes can span across plant species and genotypes, interacting with microbial soil communities to offer benefits to a wide range of crops growing under different agricultural conditions.

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

The terms “disclosure”, “invention” or “present invention” are not intended to refer to any single embodiment of the particular disclosure but encompass all possible embodiments as described in the specification and the claims.

The term “about” as used herein refer to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “fertilizer” refers to a granular or aqueous solution or suspension containing soluble nitrogen. In some examples, the soluble nitrogen in a liquid fertilizer includes an organic source of nitrogen such as urea, or urea derived from anhydrous ammonia (such as a solution of urea and ammonium nitrate (UAN)). Aqua ammonia (20-32% anhydrous ammonia) can also be used. In other examples, the soluble nitrogen in a liquid fertilizer includes nitrogen-containing inorganic salts such as ammonium hydroxide, ammonium nitrate, ammonium sulfate, ammonium pyrophosphate, ammonium thiosulfate or combinations of two or more thereof. In some embodiments the liquid fertilizer includes a non-naturally occurring nitrogen source (such as ammonium pyrophosphate or ammonium thiosulfate) and/or other non-naturally occurring components. Common liquid non-natural fertilizer blends are specified by their content of nitrogen-phosphate-potassium (N—P—K percentages) and include addition of other components, such as sulfur or zinc. Examples of human-made blends include 10-34-0, 10-30-0 with 2% sulfur and 0.25% zinc (chelated), 11-37-0, 12-30-0 with 3% sulfur, 2-4-12, 2-6-12, 4-10-10, 3-18-6, 7-22-5, 8-25-3, 15-15-3, 17-17-0 with 2% sulfur, 18-18-0, 18-18-0 with 2% sulfur, 28-0-0 UAN, 9-27-0 with 2% sulfur and potassium thiosulfate.

As used herein, “microbe” refers to a microorganism, including but not limited to bacteria, archaebacteria, fungi, and algae (such as microalgae). In some examples, microbes are single-cellular organisms (for example, bacteria, cyanobacteria, some fungi, or some algae). In other examples, the term microbes includes multi-cellular organisms, such as certain fungi or algae (for example, multicellular filamentous fungi or multicellular algae).

As used herein, “microbial composition” refers to a composition (which can be solid, liquid, or at least partially both) that includes at least one microbe (or a population of at least one microbe). In some examples, a microbial composition is one or more microbes (or one or more populations of microbes) in a liquid medium (such as a storage, culture, or fermentation medium), for example, as a suspension in the liquid medium. In other examples, a microbial composition is one or more microbes (or one or more populations of microbes) on the surface of or embedded in a solid or gelatinous medium (including but not limited to a culture plate), or a slurry or paste.

The term “microbial consortium” refers to a mixture, association, or assemblage of two or more microbial species, which in some instances are in physical contact with one another. The microbes in a consortium may affect one another by direct physical contact or through biochemical interactions, or both. For example, microbes in a consortium may exchange nutrients, metabolites, or gases with one another. Thus, in some examples, at least some of the microbes in a consortium may be metabolically interdependent. Such interdependent interactions may change in character and extent through time and with changing culture conditions.

To the extent to which any of the preceding definitions is inconsistent with definitions provided in any patent or non-patent reference incorporated herein by reference, any patent or non-patent reference cited herein, or in any patent or non-patent reference found elsewhere, it is understood that the preceding definition will be used herein.

SP-1 is a biofertilizer, designed to manufacture fertility in the soil. This technology contains a diverse community of microbes, plant-based humus extracts and algae that work together to transform soil structure, make more nutrients available and improve water use efficiency. SP-1 can aggregate and reinoculate soil, improve air and water movement, and ultimately achieve stronger, greener turf.

SP-1 is a stable, non-toxic, liquid biofertilizer product. It is a biologically diverse group of live micro-organisms, which, when successfully inoculated into the rhizosphere of growing plants, improves the availability and delivery of essential nutrients. As well known to those of ordinary skill in the art of plant physiology, improvements to plant mineral nutrition lead to many benefits.

SP-1 acts as a comprehensive system, improving soil and turf health in one clear, environmental solution. SP-1 includes:

1. Proprietary Plant-Based Humus Extract—Creates an ecosystem for water, nutrients and microbes, building a symbiotic environment ideal for essential nutrient exchange—effectively attaching the nutrients to the roots for uptake. This plant-based humus extract supports the development of an ecosystem for water, nutrients, and microbes, building a symbiotic ecosystem that is conducive to the exchange of essential nutrients, ultimately attaching microbes to the roots for uptake.

2. Plant Growth Promoting Rhizobacteria (PGPR)—Releases free-living bacteria that colonize the rhizosphere, breaking down organic matter, releasing bound nitrogen, solubilizing phosphorus and cycling nutrients to become more available for the plant.

3. Algae—Provides green manure that quickly breaks down and releases nitrogen into soil, becoming a food source for the microbes as well as the plant.

4. Fermented Plant Extracts—Impacts microbial diversity and stabilizes overall formulation through a diverse blend of plant extracts.

SP-1 comprises multiple Bacillus bacteria including Bacillus amyloliquifaciens, Bacillus lichenformis, Bacillus megaterium, Bacillus pumilis, and the fungus Trichoderma harzarium. In one embodiment, this invention includes a solution containing humus extract and a consortium of green microalgae including the genus Scenedesmus spp. These are blended in a solution with a starter fertilizer at a ratio from 1:4, 2:3, 3:2, 4:1. This blend remains stable for multiple months.

Current products comprising SP-1 include SP-1 and TerraTrove SP-1 Classic sold by Douglas Plant Health, listed as product code dpb-18449 by the Organic Materials Review Institute. However, no products are currently in the market which comprise SP-1 in combination with other fertilizer.

There is a need for both convenience of putting a plant-based humus together with synthetic pesticides, and there is stabilization of the formulation by mixing the microbial consortium in the presence of other fertilizers.

The addition of SP-1 to starter fertilizer makes it more effective for the grower through improved efficacy of the starter when combining it with SP-1. This combination results in solubilizing some of the nutrients that are in starter and making those nutrients better available to the plant.

Microbial bio-fertilizers are typically added as a tank mix at the point of application to minimize microbial loss in mixture with starter fertilizer. In one embodiment, this invention deploys a blend of bacteria, algae, and fungi in a blend with starter fertilizer with humus extract. This mixture is typically applied in-furrow at seeding, sidedressed after planting, injected in irrigation systems, or as a foliar broadcast treatment.

In one embodiment, the combination of a plant based humus with pesticides adds convenience to the grower. In another embodiment, the combination of the plant based humus with the synthetic pesticide adds stabilization of the formulation.

In certain embodiments, the invention provides a convenient all in one stabilized solution that does not require mixing at the point of use risking mis-application due to improperly measured individual components. The instant invention ensures that the dosing of microorganisms is properly applied.

In some examples, treatment of soil, seeds, plants, or plant parts with a composition comprising the microbes in the disclosed microbial consortium increases plant growth (such as overall plant size, amount of foliage, root number, root diameter, root length, production of tillers, fruit production, pollen production, or seed production) by at least about 5%.

In other examples, the disclosed methods result in increased crop production of about 10-75% compared to untreated crops. Other measures of crop performance include quality of fruit, yield, starch or solids content, sugar content or brix, shelf-life of fruit or harvestable product, production of marketable yield or target size, quality of fruit or product, grass tillering and resistance to foot traffic in turf, pollination and fruit set, bloom, flower number, flower lifespan, bloom quality, rooting and root mass, crop resistance to lodging, abiotic stress tolerance to heat, drought, cold and recovery after stress, adaptability to poor soils, level of photosynthesis and greening, and plant health. To determine efficacy of products, controls include the same agronomic practices without addition of microbes, performed in parallel.

The disclosed methods can be used in connection with any crop (for example, for direct crop treatment or for soil treatment prior to or after planting). Exemplary crops include, but are not limited to alfalfa, almond, banana, barley, broccoli, canola, carrots, citrus and orchard tree crops, cannabis, corn, cotton, cucumber, flowers and ornamentals, garlic, grapes, hops, horticultural plants, leek, melon, oil palm, onion, peanuts and legumes, pineapple, poplar, pine and wood-bearing trees, potato, raspberry, rice, sesame, sorghum, soybean, squash, strawberry, sugarcane, sunflower, tomato, turf and forage grasses, watermelon, wheat, and eucalyptus.

The following examples are provided to illustrate certain particular features and/or embodiments. These examples should not be construed to limit the disclosure to the particular features or embodiments described.

### Embodiments

Various embodiments of the systems and methods provided herein are included in the following non-limiting list of embodiments. These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

1. A fertilizer composition comprising:
a stabilized microbial consortium comprising a plant-based humus extract; and
a starter fertilizer,
wherein the stabilized microbial consortium and the starter fertilizer are in a weight ratio of from about 1:4 to about 4:1.

2. The fertilizer composition of embodiment 1, wherein the weight ratio of stabilized microbial consortium to starter fertilizer is from about 2:3 to about 3:2.

3. The fertilizer composition of embodiment 1, wherein the weight ratio of stabilized microbial consortium to starter fertilizer is about 1:1.

4. The fertilizer composition of any one of embodiments 1 to 3, wherein the stabilized microbial consortium further comprises a rhizobacteria.

5. The fertilizer composition of embodiment 4, wherein the rhizobacteria comprises Bacillus amyloliquifaciens, Bacillus lichenformis, Bacillus megaterium, Bacillus pumilis, and combinations thereof.

6. The fertilizer composition of any one of embodiments 1 to 5, wherein the stabilized microbial consortium further comprises a green microalgae, a green microalgae extract, or combinations thereof.

7. The fertilizer composition of embodiment 6, wherein the green microalgae comprises Scenedesmus spp.

8. The fertilizer composition of any one of embodiments 1 to 7, wherein the stabilized microbial consortium further comprises a fungus.

9. The fertilizer composition of embodiment 8, wherein the fungus comprises Trichoderma harzarium.

10. The fertilizer composition of any one of embodiments 1 to 9, wherein the stabilized microbial consortium further comprises a fermented plant extract.

11. The fertilizer composition of any one of embodiments 1 to 10, wherein the stabilized microbial consortium comprises at least about 50% by weight humus extract.

12. The fertilizer composition of any one of embodiments 1 to 11, wherein the stabilized microbial consortium comprises about 75% by weight humus extract.

13. The fertilizer composition of any one of embodiments 1 to 12, wherein the starter fertilizer comprises a synthetic starter fertilizer.

14. The fertilizer composition of any one of embodiments 1 to 13, further comprising a carrier.

15. The fertilizer composition of any one of embodiments 1 to 14, wherein the fertilizer composition is shelf stable for at least about 1 month, at least about 2 months, or at least about 3 months.

16. A method of increasing crop yield comprising:
applying to a crop the fertilizer composition of any one of embodiments 1 to 15.

17. A method of reducing the amount of starter fertilizer used in crop production comprising:
applying to a crop the fertilizer composition of any one of embodiments 1 to 15.

18. A method of improving the effectiveness of starter fertilizer comprising: combining a starter fertilizer and a stabilized microbial consortium comprising a plant-based humus extract to obtain a fertilizer composition, wherein the stabilized microbial consortium and the starter fertilizer are in a weight ratio of from about 1:4 to about 4:1; and applying the fertilizer composition to a crop.

19. The method of any one of embodiments 16 to 18, wherein the fertilizer composition is applied in-furrow.

20. The method of any one of embodiments 16 to 18, wherein the fertilizer composition is applied sidedressed.

21. The method of any one of embodiments 16 to 18, wherein the fertilizer composition is injected in an irrigation system and applied during an irrigation.

22. The method of any one of embodiments 16 to 18, wherein the fertilizer composition is applied foliar.

23. The method of embodiment 22, wherein the fertilizer composition is applied as a foliar broadcast treatment.

24. The method of any one of embodiments 16 to 23, wherein the application comprises from about 0.5 gal/A to about 2 gal/A, or from about 1 gal/A to about 1.5 gal/A of the fertilizer composition.

25. The method of any one of embodiments 16 to 24, wherein the crop comprises corn, soybeans, forages, potatoes, tomatoes, trees, vines, citrus, nuts, and/or woody crops.

26. The method of any one of embodiments 16 to 25, wherein the crop yield is increased by at least about 10% or by at least about 15%.

27. The method of any one of embodiments 17 to 26, wherein the method reduces the amount of starter fertilizer used in crop production by at least about 10% by weight, by at least about 25% by weight, or at least about 50% by weight.

28. The method of any one of embodiments 18 to 27, wherein the method improves the effectiveness of the starter fertilizer by at least about 10%, at least about 15%, at least about 25%, or at least about 50%.

### Examples

SP-1 Performance in Corn in Combination with Starter Fertilizer.

Objective: Evaluate performance of SP-1 plus commercial starter fertilizer on corn plant growth and yield across multiple Corn Belt locations in IA, IL, MN, NE, and SD.

Methods and materials: SP-1 Biofertilizer was applied in-furrow at 2 gal/acre in combination with various commercial starter fertilizers (commercial starter fertilizers with typical nitrogen, phosphorous, potassium (NPK) analysis such as: 6-24-6; 9-24-3; 10-34-0; 32% UAN (Urea ammonium nitrate) vs. the Grower Standard Practice (GSP). Trials were planted with commercial planting equipment, following local area standard agronomic practices for weed control, planting density, and hybrid selection.

Experimental design: Locations were planted as a randomized complete block design (RCBD) with 4 reps OR into 40-100 acre fields with alternating strips of the SP-1 with or without the starter fertilizer treatment. Data was analyzed and ANOVA mean separation was performed using least significant differences (lsd α=0.10). Treatments are as in indicated in Table 1.

### Experiment Details:

Crop: Corn
Product Application Details: SP-1 applied in furrow tank mixed with liquid startup fertilizer.
Experimental Design: Split a 40-100 acre field into alternating strips that will receive the following treatments:

TABLE 1

| | Application | | Application |
|---|---|---|---|
| Treatment | Timing | Product | Rate |
| 1 | In furrow at | Grower | Grower |
| | planting | Standard | Standard Rate |
| | | Practice | |
| 2 | In furrow at | Grower | Grower |
| | planting | Standard | Standard Rate |
| | | Practice | |
| | | SP-1 | 2 gallons/Acre |
| 3 (optional, | In furrow at | Grower | 50% Grower |
| conducted at | planting | Standard | Standard Rate |
| two locations | | Practice | |
| only) | | SP-1 | 2 gallons/Acre |

Results: SP-1 performed equal to or better than Grower Standard Practice starter treatment in multiple locations. In Corydon IA (FIG. 4) SP-1 performed equal to the Grower Standard at 50% of the rate of the commercial fertilizer 10-34-0.
Conclusions: SP-1 performance equal to or better than commercial starter fertilizer used as a grower standard is a novel approach to more efficient commercial fertilizer usage with a potentially significant cost advantage to growers. SP-1 biofertilizer also mitigates potential injury from the high salt index present in some commercial starter fertilizers.

What is claimed is:

1. A fertilizer composition comprising:
a stabilized microbial consortium comprising a plant-based humus extract; and
a starter fertilizer,
wherein the stabilized microbial consortium and the starter fertilizer are in a weight ratio of from about 1:4 to about 4:1.

2. The fertilizer composition of claim 1, wherein the weight ratio of stabilized microbial consortium to starter fertilizer is from about 2:3 to about 3:2.

3. The fertilizer composition of claim 1, wherein the weight ratio of stabilized microbial consortium to starter fertilizer is about 1:1.

4. The fertilizer composition of claim 1, wherein the stabilized microbial consortium further comprises a rhizobacteria.

5. The fertilizer composition of claim 4, wherein the rhizobacteria comprises Bacillus amyloliquifaciens, Bacillus lichenformis, Bacillus megaterium, Bacillus pumilis, and combinations thereof.

6. The fertilizer composition of claim 1, wherein the stabilized microbial consortium further comprises a green microalgae, a green microalgae extract, or combinations thereof.

7. The fertilizer composition of claim 6, wherein the green microalgae comprises Scenedesmus spp.

8. The fertilizer composition of claim 1, wherein the stabilized microbial consortium further comprises a fungus.

9. The fertilizer composition of claim 8, wherein the fungus comprises Trichoderma harzarium.

10. The fertilizer composition of claim 1, wherein the stabilized microbial consortium further comprises a fermented plant extract.

11. The fertilizer composition of claim 1, wherein the stabilized microbial consortium comprises at least about 50% by weight humus extract.

12. The fertilizer composition of claim 1, wherein the stabilized microbial consortium comprises about 75% by weight humus extract.

13. The fertilizer composition of claim 1, wherein the starter fertilizer comprises a synthetic starter fertilizer.

14. The fertilizer composition of claim 1, further comprising a carrier.

15. The fertilizer composition of claim 1, wherein the fertilizer composition is shelf stable for at least about 1 month, at least about 2 months, or at least about 3 months.

16. A method of increasing crop yield comprising:
applying to a crop the fertilizer composition of claim 1.

17. A method of reducing the amount of starter fertilizer used in crop production comprising:
applying to a crop the fertilizer composition of claim 1.

18. A method of improving the effectiveness of starter fertilizer comprising:
combining a starter fertilizer and a stabilized microbial consortium comprising a plant-based humus extract to obtain a fertilizer composition, wherein the stabilized microbial consortium and the starter fertilizer are in a weight ratio of from about 1:4 to about 4:1; and applying the fertilizer composition to a crop.

19. The method of any one of claims 16 to 18, wherein the fertilizer composition is applied in-furrow.

20. The method of any one of claims 16 to 18, wherein the fertilizer composition is applied side dressed.

21. The method of any one of claims 16 to 18, wherein the fertilizer composition is injected in an irrigation system and applied during an irrigation.

22. The method of any one of claims 16 to 18, wherein the fertilizer composition is applied foliar.

23. The method of claim 22, wherein the fertilizer composition is applied as a foliar broadcast treatment.

24. The method of claim 16, wherein the application comprises from about 0.5 gal/A to about 2 gal/A, or from about 1 gal/A to about 1.5 gal/A of the fertilizer composition.

25. The method of claim 16, wherein the crop comprises corn, soybeans, forages, potatoes, tomatoes, trees, vines, citrus, nuts, and/or woody crops.

26. The method of claim 16, wherein the crop yield is increased by at least about 10% or by at least about 15%.

27. The method of claim 17, wherein the method reduces the amount of starter fertilizer used in crop production by at least about 10% by weight, by at least about 25% by weight, or at least about 50% by weight.

28. The method of claim 18, wherein the method improves the effectiveness of the starter fertilizer by at least about 10%, at least about 15%, at least about 25%, or at least about 50%.
